(19) United States
(12) Patent Application Publication
(10) Pub. No.: US 2025/0207516 A1
(43) Pub. Date: Jun. 26, 2025

(54) THERMAL ENERGY CONVERSION METHOD AND SYSTEM

(71) Applicant: Hans Gude Gudesen, Gamle Fredrikstad (NO)

(72) Inventors: Hans Gude Gudesen, Luzern (CH); Per-Erik Nordal, Asker (NO)

(73) Assignee: Hans Gude Gudesen, Gamle Fredrikstad (NO)

(21) Appl. No.: 18/848,124

(22) PCT Filed: Mar. 17, 2023
(86) PCT No.: PCT/NO2023/050059

§ 371 Date: Sep. 17, 2024

(30) Foreign Application Priority Data
Mar. 18, 2022 (NO) 20220335

(51) Int. Cl. F01K 25/02; F01K 25/10

(52) U.S. Cl. CPC F01K 25/02; F01K 25/10

(57) ABSTRACT

A thermal energy conversion method is disclosed, where the method comprises establishing a pressure differential between working fluid vapor pressures in two working volumes and driving a hydraulic device by the pressure differential, thereby generating mechanical energy. A corresponding thermal energy conversion system is also disclosed.

### FIELD OF THE INVENTION

The present invention relates a method for converting thermal energy into mechanical energy and a corresponding system.

### BACKGROUND OF THE INVENTION

Engines that are able to convert thermal energy into mechanical energy have played a central role since the dawn of the industrial revolution, and novel concepts in this field are still emerging. One important trend of particular relevance in the present context is towards operation with low temperature thermal sources. One example is the Organic Rankine cycle (ORC) (https://en.wikipedia.org/wiki/Organic_Rankine_cycle) where working fluids other than water, e.g. n-pentane and toluene, are employed with volatility characteristics that permit operation with low grade heat sources, typically in the range 100° C.-200° C. However, at the lower part of this temperature range and in particular below 70° C. there are at present no generally applicable concepts that can deliver adequate commercially relevant performance. Unfortunately, this is the temperature range where there exist vast untapped thermal energy resources around the globe. There is therefore a pressing need for concepts that can employ these energy reserves to generate mechanical power and electricity.

### SUMMARY OF THE INVENTION

A first aspect of the invention is a method for converting thermal energy into mechanical energy where the method comprises the following steps:
injecting heat into a working fluid in a heat exchange volume by a thermally connected heat exchanger, and extracting heat from a working fluid in another heat exchange volume by a thermally connected heat exchanger, thereby establishing and maintaining within predefined ranges temperatures of respectively T_{High} and T_{Low}<T_{High} and a pressure differential between working fluid vapor pressures in the two heat exchange volumes, where the heat exchange volume where heat is injected contains working fluid at least partially in the liquid phase, and the temperatures T_{High} and T_{Low} lie between the triple point temperature and the critical point temperature of the working fluid, and
by the pressure differential, driving a hydraulic power conversion device fluidly connected to the two heat exchange volumes, thereby generating mechanical energy.

Optionally, the method comprises operating the hydraulic power conversion device under load conditions such that the fluid is discharged from the hydraulic power conversion device at a pressure equal to or exceeding the liquid to vapor equilibrium pressure of the working fluid at the temperature T_{Low}.

Optionally, the method comprises cyclically switching the injecting heat and the extracting heat between the two heat exchange volumes.

Optionally, the method comprises performing the injecting and the extracting heat respectively in the one and the other heat exchange volume, and cyclically switching the fluid connection between the two heat exchange volumes and the hydraulic power conversion device, and further optionally, the switching the fluid connection comprises controlled opening and closing and valves and ducts between the hydraulic power conversion device and the heat exchange volumes, and further optionally, the method comprises transferring working fluid in liquid form from the heat exchange volume where heat is extracted to the heat exchange volume where heat is injected via a flow control device, where the transferring working fluid in liquid form is performed either continuously or intermittently.

Optionally, the driving the hydraulic power conversion device comprises cyclically exposing one or more displacement elements comprised by the hydraulic power conversion device to working fluid from the two heat exchange volumes.

Optionally, the driving the hydraulic power conversion device comprises allowing the pressure differential to sustain a flow of working fluid in liquid or gaseous phase through the hydraulic power conversion device between the two heat exchange volumes.

Optionally, the driving the hydraulic power conversion device comprises sustaining a flow of a hydraulic liquid through the hydraulic power conversion device by the differential pressure.

Optionally, the sustaining the flow of the hydraulic liquid through the hydraulic power conversion device comprises transmitting working fluid vapor pressure via moveable separation elements to the hydraulic liquid.

Optionally, the sustaining the flow of the hydraulic liquid through the hydraulic device comprises allowing the working fluid vapor pressures acting directly on a free surface of the hydraulic liquid.

Another aspect of the invention is a system for converting thermal energy into mechanical energy where the system comprises:
two heat exchange volumes containing working fluid, each thermally connected to a separate heat exchanger; and
a hydraulic power conversion device fluidly connected to the two heat exchange volumes, and arranged to generate mechanical energy by a pressure differential between working fluid vapor pressures in the two heat exchange volumes;

where the system is arranged for at a given time injecting heat in one of the heat exchange volumes containing working fluid at least partially in liquid phase and thereby establishing and maintaining within predefined range a temperature of T_{High}, and extracting heat from the other heat exchange volume thereby establishing and maintaining within predefined ranges a temperature of T_{Low}<T_{High}, where the temperatures T_{High} and T_{Low} lie between the triple point temperature and the critical point temperature of the working fluid.

Optionally, the system comprises means adapted to cyclically switching the injecting heat and the extracting heat between the two heat exchange volumes.

Optionally, the system is adapted to constantly performing the injecting heat in one of the heat exchange volumes and the extracting heat from the other heat exchange volume, and comprises means adapted to cyclically switching the fluid connection between the two heat exchange volumes and the hydraulic power conversion device, and further optionally, the means adapted to cyclically switching the fluid connection comprises valves and ducts arranged between the hydraulic power conversion device and the heat exchange volumes, and a control unit adapted to opening and closing the valves, and even further optionally, the system comprises means adapted to transferring working fluid in liquid form from the heat exchange volume where heat is extracted to the heat exchange volume where heat is injected, where the means adapted to transferring working fluid comprises a flow control device arranged in fluid connection with lower parts of the heat exchange volumes and is adapted to transfer the working fluid in liquid form either continuously or intermittently.

Optionally, the hydraulic power conversion device comprises one or more displacement elements, and the system comprises means for cyclically exposing the displacement elements to working fluid from the two heat exchange volumes, where the displacement elements optionally comprise one or more of the following: A piston, a membrane, a telescopic tube, a bellows, a flexible bladder or balloon, rotary screws.

Optionally, the system comprises means allowing the pressure differential to sustain a flow of working fluid in liquid or gaseous phase through the hydraulic power conversion device between the two heat exchange volumes, where the hydraulic power conversion device optionally comprises a turbine, a scroll expander or a rotary screw device.

Optionally, the system comprises means adapted to sustaining a flow of a hydraulic liquid through the hydraulic power conversion device by the differential pressure, where the hydraulic liquid optionally is water.

Optionally, the system comprises means adapted to transmitting working fluid vapor pressure via moveable separation elements to the hydraulic liquid, where optionally the separation elements comprise at least one of the following: A piston, a membrane, a telescopic tube, a bellows, a flexible bladder or balloon.

Optionally, the system comprises means adapted to allowing the working fluid vapor pressures acting directly on a free surface of the hydraulic liquid, where optionally the hydraulic liquid and the two liquid phase working fluids are arranged in separate lower parts of a closed volume providing for separation of the liquids, still allowing the working fluid vapor pressures acting on the free surface of the hydraulic liquid.

### DESCRIPTION OF THE FIGURES

The above and other features of the invention are set forth with particularity in the appended claims and together with advantages thereof will become clearer from consideration of exemplary embodiments of the invention given with reference to the accompanying drawings.

Embodiments of the present invention will now be described, by way of example only, with reference to the following figures, wherein:

FIG. 1 shows a model system for explanation of the basic principles behind the present invention.

FIG. 2 shows part of the CO₂ phase diagram.

FIGS. 3a-d show a preferred embodiment of the present invention where the working fluid interacts directly with a hydraulic device.

FIGS. 4a-d show a preferred embodiment of the present invention where the working fluid interacts indirectly via pistons and a second liquid with a hydraulic device.

FIGS. 5a-d show a preferred embodiment of the present invention where the working fluid interacts indirectly and without pistons via a second liquid with a hydraulic device.

FIG. 6 shows a preferred embodiment of the present invention where the working fluid is heated, respectively cooled in separate vessels fluidly connected with a hydraulic power conversion device.

### LIST OF REFERENCE NUMBERS IN THE FIGURES

The following reference numbers refer to the drawings:

| Number | Designation |
|---|---|
| 1 | Cylinder |
| 2, 3 | Compartment |
| 4 | Piston |
| 5 | Shaft |
| 6, 7 | Liquid phase working fluid |
| 8, 9 | Vapor phase working fluid |
| 10, 11 | Thermal transfer element |
| 12, 13 | Heat flux in/out |
| 14, 15 | Liquid phase working fluid |
| 16, 17 | Vapor phase working fluid |
| 18, 19 | Vessel |
| 20 | Channel |
| 21 | Hydraulic device |
| 22, 23 | Thermal transfer element |
| 24, 25 | Second liquid |
| 26, 27 | Piston |
| 28, 29 | Vessel |
| 30, 31 | Vessel |
| 32, 33 | Channel |
| 34, 35 | Second liquid |
| 36, 37 | Vapor phase working fluid |
| 38, 39 | Vapor phase working fluid |
| 40, 41 | Vessel |
| 42, 43 | Liquid CO₂ |
| 44, 45 | Gaseous CO₂ |
| 46, 47 | Heat exchanger system |
| 48, 49 | Cylinder |
| 50, 51, 52, 53 | Control valve |
| 54, 55, 56, 57 | Tube |
| 58, 59 | Gaseous CO₂ |
| 60, 61 | Piston |
| 62 | Rod |
| 63 | Electrical generator |
| 64 | Flow control device |

### DESCRIPTION OF PREFERRED EMBODIMENTS OF THE INVENTION

The present invention exploits the strong dependence of the equilibrium vapor pressure on temperature for liquid/vapor phase transitions in certain fluids and temperature regimes. This is described in the following with reference to the accompanying drawings. Before proceeding to descriptions of some exemplary embodiments of the invention, the basic principles of the present invention shall be explained:

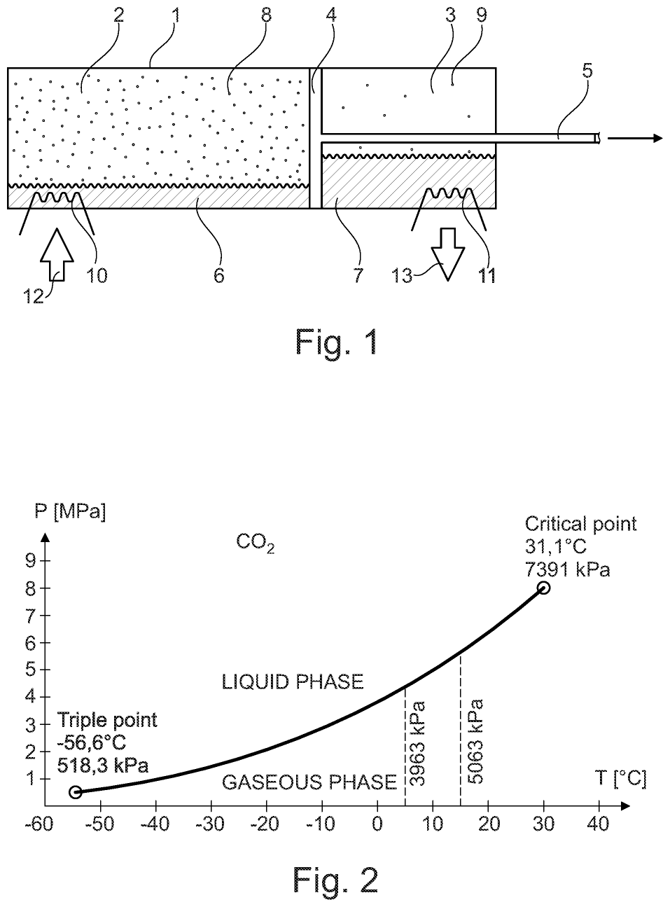

FIG. 1 shows a closed system at one of several stages in a cyclic sequence of events where thermal energy is exchanged with a working fluid to create net mechanical power. The system comprises a cylinder (1) which is divided into two compartments (2), (3) by a piston (4). The piston can move left/right and is linked to a shaft (5) which extends through the end wall of the cylinder and can transfer mechanical force to the exterior. Both compartments contain a working fluid in liquid (6), (7) and vapor (8), (9) phases, but are maintained at different temperatures by thermal transfer elements (10), (11) each of which can provide heating and cooling as required. The thermal transfer elements are represented in FIG. 1 by identical symbols, but may in practice be configured in various ways.

Operation: Consider first a near-equilibrium situation where the piston is stationary, i.e. it is locked in place and cannot move. Compartment (2) is maintained at a temperature T_{High} by thermal transfer element (10), and the vapor pressure p(T_{High}) in compartment (2) is defined by the gas/liquid equilibrium pressure for the working fluid at T_{High}. Likewise, compartment (3) is maintained by thermal transfer element (11) at a temperature T_{Low} and the vapor pressure p(T_{Low}) is defined by the gas/liquid equilibrium pressure at T_{Low}. For concreteness it shall be assumed here that the working fluid is CO₂ and the temperatures are T_{High}=15° C., T_{Low}=5° C. FIG. 2 shows part of the CO₂ phase diagram between the triple point and the critical point, from which one may note that the liquid/gas equilibrium vapor pressures are p(15° C.)=5,063 MPa, p(5° C.)=3,963 MPa. Thus, a temperature differential of only 10° C. corresponds to a change in equilibrium vapor pressure 1.1 MPa, or 11 bar. This is the differential pressure acting on the piston (4) in FIG. 1. Mechanical energy can be extracted by releasing the piston, allowing it to push the shaft (5) to the right against a mechanical resistance that consumes the energy. When the piston moves, the volume in compartment (2) increases, lowering the vapor pressure and causing some of the working fluid in liquid phase (6) to evaporate. This in turn cools down the working fluid in compartment (2), and in the absence of the thermal transfer element (10) causing a heat flux (12) to transfer into the compartment and maintain the temperature at T_{High}, the vapor pressure in (2) would drop to a lower value and net evaporation would stop. On the other side of the piston, the situation is different: When the piston moves to the right in FIG. 1 the volume in compartment (3) decreases, the vapor pressure and temperature increase and some vapor phase working fluid (9) condenses to liquid (7) giving off condensation heat. In the absence of the thermal transfer element (11) causing a heat flux (13) to transfer out of the compartment (3) and maintain the temperature at T_{Low}, the vapor pressure in (3) would rise, adding a counterpressure on the piston (4) and ultimately arresting the condensation of working fluid. By balancing the heat transfer into and out of the system against the extraction of mechanical energy, the piston can complete a power stroke from left to right, accompanied by evaporation of liquid working fluid in the left compartment at temperature T_{High} and condensation in the right compartment at temperature T_{Low}. When the piston has reached a point defining the end of its travel to the right inside the cylinder (1), it is locked in place and the heat fluxes into and out of the compartments (2), (3) are reversed, bringing the temperatures in compartments (2), (3) to T_{Low}, T_{High}, respectively. Once this has been achieved, the piston is released, ready for a new power stroke, this time from right to left in FIG. 1. When the piston has reached a point defining the end of its travel to the left inside the cylinder (1), it is locked in place and the heat fluxes into and out of the compartments (2), (3) are reversed once more, bringing the temperatures in compartments (2), (3) to T_{High}, T_{Low}, respectively and preparing the system for a new power stroke to the right.

In the example discussed above, CO₂ was chosen as the working fluid, which provided access to thermal sources in a temperature interval between the triple point (−56.6° C.) and the critical point (31.1° C.). More generally, a wide range of working fluids exist that can extend the range of operational temperatures and provide other properties of interest, e.g. relating to toxicity, density, thermal characteristics, chemical reactivity and miscibility with other fluids, etc., including one or more of the following, alone or in a mixture: water, carbon dioxide, ammonia, a Freon compound, a hydrocarbon, a halogenated hydrocarbon, tetrafluoroethane, and pentafluoropropane.

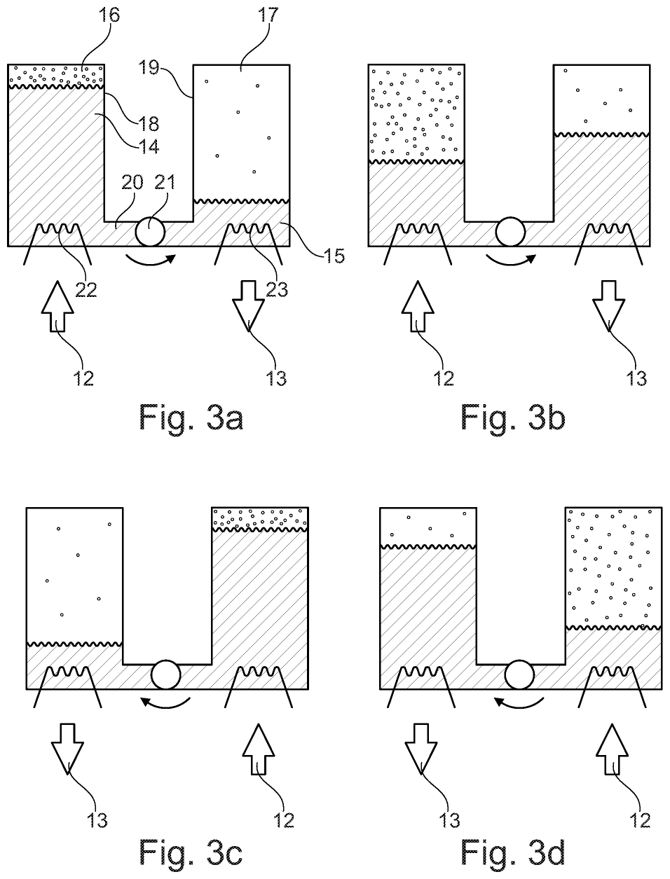

The system shown in FIG. 1 represents only one example of a configuration where differential vapor pressures can be employed to extract mechanical power. Thus, instead of a linear reciprocal motion as discussed in relation to FIG. 1, FIG. 3a shows a system at the first stage in a cyclic sequence of events where net mechanical power is created by passing the working fluid through a turbine. The working fluid which is partly in liquid phase (14), (15), partly in vapor phase (16), (17) is contained within a closed system consisting of two vessels (18), (19) that are connected via a channel (20). A reversible hydraulic device (21) in the channel can interact with liquid flowing through the channel. At the cycle stage shown in FIG. 3a the left vessel (18) is filled with working fluid at a specific elevated temperature T_{High}. The working fluid is predominantly in liquid phase (14), with a small amount of vapor phase (16) at a pressure p(T_{High}) which in the present context shall be assumed close to the liquid/vapor equilibrium pressure at T_{High}. The right vessel (19) is nearly empty, with a small amount of liquid working fluid (15) at temperature T_{Low} in contact with a vapor phase (17) at a pressure p(T_{Low}) which in the present context shall be assumed close to the liquid/vapor equilibrium pressure at T_{Low}. Again, for concreteness and to simplify the following description, it shall be assumed that the working fluid is CO₂ and the temperatures are T_{High}=15° C., T_{Low}=5° C. At these temperatures the equilibrium vapor pressures are p(T_{High})=5.06 MPa, p(T_{Low})=3.96 Mpa. These pressures transmit via the liquid phases to the hydraulic device (21), exerting a differential pressure p(T_{High})−p(T_{Low})=1.1 MPa on the latter. Thus, by allowing liquid working fluid to flow through the hydraulic device, e.g. a turbine, mechanical energy can be extracted. As soon as liquid is drawn from the left vessel (18), however, the expanding vapor phase (16) experiences a lowered pressure and cooling, which in turn prompts net evaporation from the liquid phase (14) and further cooling. At the same time, liquid working fluid at temperature T_{High} flows into the right vessel (19), raising the temperature and pressure and contributing to reducing the pressure differential through the hydraulic device (21). In order to ensure that the flow through the hydraulic device be sustained, thermal transfer elements (22), (23) inside the vessels (18), (19) are activated as follows: In the left vessel (18) the element (22) provides heat to a degree required to maintain the temperature T_{High}, while the element (23) provides cooling to maintain the temperature T_{Low} in the right vessel (19). FIG. 3b shows the situation after a period when roughly half of the liquid phase working fluid has been transferred from the left to the right vessel. Ultimately, the liquid phase working fluid in the left vessel (18) has reached a low level and the hydraulic device (21) is stopped. There now follows a reversal procedure where the thermal transfer elements (22), (23) switch function, cooling down the remaining working fluid in vessel (18) to T_{Low} and heating the working fluid in vessel (19) to T_{High}. Once this has been achieved, working fluid is allowed to flow through the hydraulic device (assumed bidirectional) in the left direction as shown in FIG. 3c, producing mechanical power. FIG. 3d shows the situation at a later time when the left vessel (18) is filled to near capacity. The flow through the hydraulic device is then stopped, and a new reversal procedure is carried out, this time heating the working fluid in the left vessel (18) and cooling the working fluid in the right vessel (19). This restores the situation to that shown in FIG. 3a, and the system is ready for a new cycle.

Problems due to the cyclic interruption of power delivery from the system described in FIGS. 3a-d can be remedied by routing working fluid from multiple heated and cooled vessels through the hydraulic device via channels and valves that are operated in an overlapping sequence.

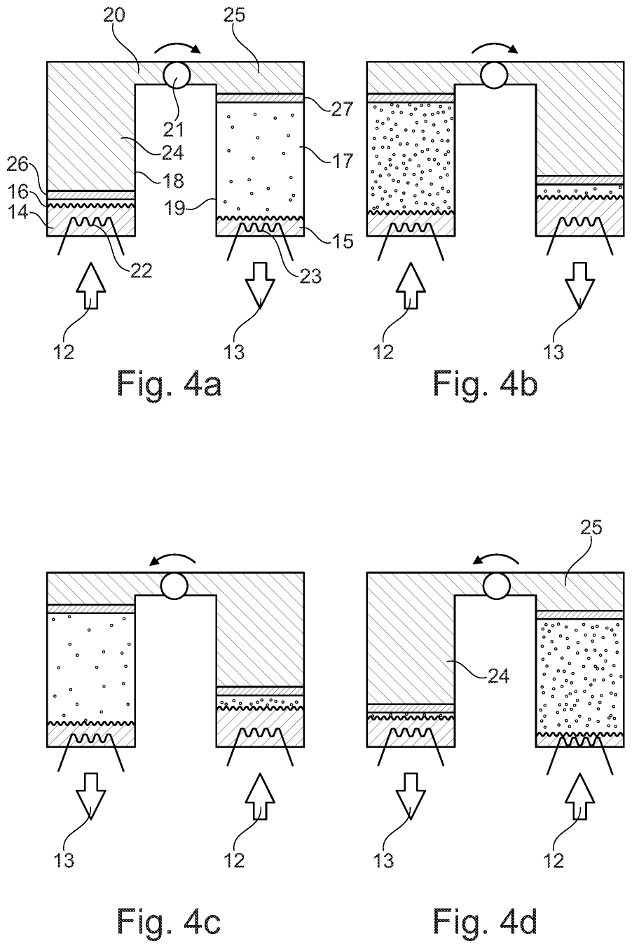

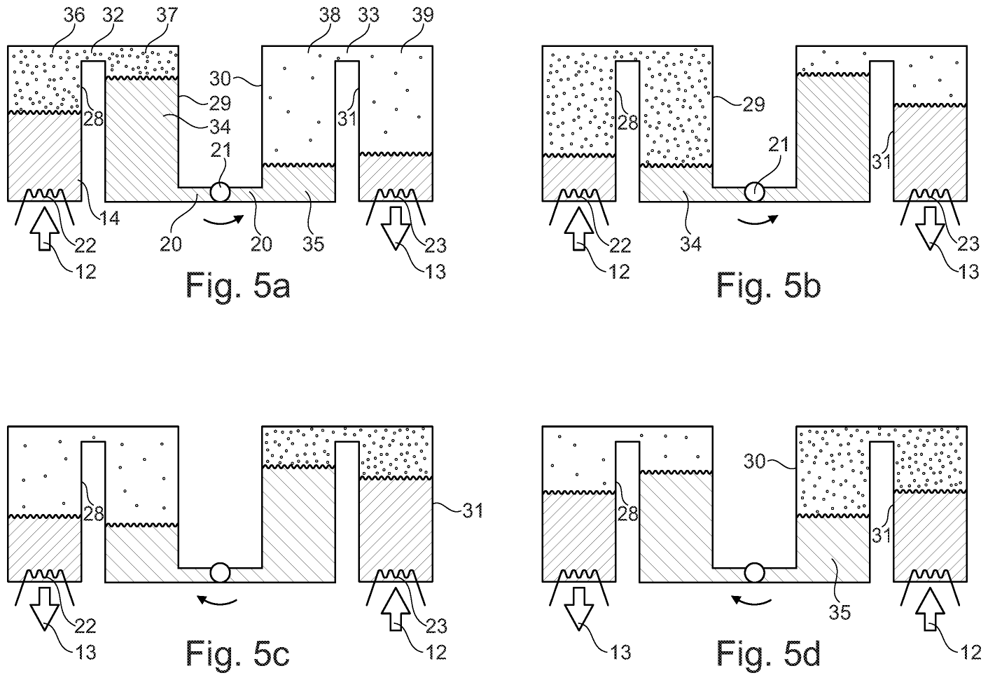

In many instances it is not practical to operate systems where the working fluid is brought into direct contact with certain parts of the system, e.g. the hydraulic device. FIGS. 4a-d show an example of a preferred embodiment where the working fluid is brought to exert pressure on a second liquid, termed a hydraulic liquid in the following, which is transported within the system and interacts with a hydraulic device. The system comprises two vessels (18), (19) that are connected via a channel (20). A reversible hydraulic device (21) in the channel can interact with hydraulic liquid flowing through the channel. The working fluid (14), (15) is physically separated from the hydraulic liquid (24), (25) by a movable piston (26), (27) in each vessel. In FIG. 4a the system is shown at the first stage in a cyclic sequence of events: In the left vessel (18) the volume below the piston is filled with working fluid at a specific elevated temperature T_{High}. The working fluid is predominantly in liquid phase (14), with a small amount of vapor phase (16) at a pressure p(T_{High}) which in the present context shall be assumed close to the liquid/vapor equilibrium pressure at T_{High}. The volume in the right vessel (19) is nearly empty, with the major part of the working fluid (15) in liquid phase at temperature T_{Low}. It is in contact with a vapor phase (17) at a pressure p(T_{Low}) which in the present context shall be assumed close to the liquid/vapor equilibrium pressure at T_{Low}. These pressures transmit via the pistons (26), (27) and the hydraulic liquid (24), (25) to the hydraulic device (21), exerting a differential pressure p(T_{High})−p(T_{Low}). By allowing the hydraulic liquid to flow through the hydraulic device, e.g. a turbine, mechanical energy can be extracted. As soon as liquid is drawn from the left vessel (18), however, the expanding vapor phase (16) experiences a lowered pressure and cooling, which in turn prompts net evaporation from the working fluid liquid phase (1) and further cooling. At the same time, hydraulic liquid at temperature T_{Hydraulic liquid} flows into the right vessel (19). Depending on T_{Hydraulic liquid}, this may raise the temperature and pressure in the right vessel and contribute to reducing the pressure differential through the hydraulic device (21). In order to ensure that the flow through the hydraulic device be sustained, thermal transfer elements (22), (23) inside the vessels (18), (19) are activated as follows: In the left vessel (18) the element (22) provides heat to a degree required to maintain a working fluid temperature T_{High}, while the element (23) provides cooling to maintain a working fluid temperature T_{Low} in the right vessel (19). FIG. 4b shows the situation at a stage where the liquid phase working fluid (14) in the left vessel (18) has reached a low level and the hydraulic device (21) must be stopped. There now follows a reversal procedure where the thermal transfer elements (22), (23) switch function, cooling down the remaining working fluid in vessel (18) to T_{Low} and heating the working fluid in vessel (19) to T_{High}. Once this has been achieved, the hydraulic liquid is allowed to flow through the hydraulic device (assumed bidirectional) in the left direction as shown in FIG. 4c, producing mechanical power. FIG. 4d shows the situation at a later time when most of the hydraulic liquid (25) has been drained from the right vessel (19). The flow through the hydraulic device is then stopped, and a new reversal procedure is carried out, this time heating the working fluid in the left vessel (18) and cooling the working fluid in the right vessel (19). This restores the situation to that shown in FIG. 4a, and the system is ready for a new cycle In FIGS. 5a-d a system is shown operating in a similar manner to that described in relation to FIGS. 4a-d, but without incorporating physical pistons: As shown in FIGS. 5a-d the system now comprises four vessels (28), (29), (30), (31) that are connected via channels (20), (32), (33). A reversible hydraulic device (21) in channel (20) can interact with liquid flowing through the channel. Liquid phase working fluid is contained in vessels (28), (31) while the hydraulic liquid (34), (35) is contained in vessels (29), (30). In FIG. 5a the system is shown at the first stage in a cyclic sequence of events: A thermal transfer element (22) maintains liquid and vapor phase working fluid in vessel (28) at a specific elevated temperature T_{High}, causing working fluid vapor (36), (37) to fill the void volumes in vessels (28), (29) at a pressure p(T_{High}) which in the present context shall be assumed close to the working fluid liquid/vapor equilibrium pressure at T_{High}. This pressure acts on the free surface of the hydraulic liquid (34) and is transmitted via the channel (20) to the hydraulic device (21). The volume in the right vessel (30) is nearly empty, with a small amount of hydraulic liquid (35) at the bottom. Vessel (31) contains working fluid in liquid and vapor phases, maintained at temperature T_{Low} by thermal transfer element (23). Working fluid vapor (38), (39) fills the void volumes in vessels (30), (31) at a pressure p(T_{Low}) which in the present context shall be assumed close to the working fluid liquid/vapor equilibrium pressure at T_{Low}. This pressure acts on the free surface of the hydraulic liquid (35) and is transmitted via the channel (20) to the hydraulic device (21) which is subjected to a differential pressure p(T_{High})−p(T_{Low}). By allowing the hydraulic liquid to flow through the hydraulic device, e.g. a turbine, mechanical energy can be extracted. As soon as hydraulic liquid is drawn from the vessel (29), the expanding vapor phase working fluid (36), (37) in vessels (28), (29) experience a lowered pressure and cooling, which in turn prompts net evaporation from the working fluid liquid phase (14) and further cooling. At the same time, hydraulic liquid flows into vessel (30). This may raise the temperature and pressure in vessels (30), (31) and contribute to reducing the pressure differential through the hydraulic device (21). In order to ensure that the flow through the hydraulic device be sustained, the thermal transfer element (23) inside vessel (31) is activated to provide cooling to maintain a working fluid temperature T_{Low} in the vessel (31). FIG. 5b shows the situation at a stage where the hydraulic liquid (34) in vessel (29) has reached a low level and the hydraulic device (21) must be stopped. As shown in FIG. 5c there now follows a reversal procedure where the thermal transfer elements (22), (23) switch function, cooling down the remaining working fluid in vessel (28) to T_{Low} and heating the working fluid in vessel (31) to T_{High}. Once this has been achieved, the hydraulic liquid is allowed to flow through the hydraulic device (assumed bidirectional) in the left direction as shown in FIG. 5c, producing mechanical power. FIG. 5d shows the situation at a later time when more of the hydraulic liquid (35) has been drained from vessel (30). The flow through the hydraulic device is then stopped, and a new reversal procedure is carried out, this time heating the working fluid in vessel (28) and cooling the working fluid in vessel (31). This restores the situation to that shown in FIG. 5a, and the system is ready for a new cycle

In FIGS. 5a-d a system is shown operating in a similar manner to that described in relation to FIGS. 4a-d, but without incorporating physical pistons: As shown in FIGS. 5a-d the system now comprises four vessels (28), (29), (30), (31) that are connected via channels (20), (32), (33). A reversible hydraulic device (21) in channel (20) can interact with liquid flowing through the channel. Liquid phase working fluid is contained in vessels (28), (31) while the hydraulic liquid (34), (35) is contained in vessels (29), (30). In FIG. 5a the system is shown at the first stage in a cyclic sequence of events: A thermal transfer element (22) maintains liquid and vapor phase working fluid in vessel (28) at a specific elevated temperature T_{High}, causing working fluid vapor (36), (37) to fill the void volumes in vessels (28), (29) at a pressure p(T_{High}) which in the present context shall be assumed close to the working fluid liquid/vapor equilibrium pressure at T_{High}. This pressure acts on the free surface of the hydraulic liquid (34) and is transmitted via the channel (20) to the hydraulic device (21). The volume in the right vessel (30) is nearly empty, with a small amount of hydraulic liquid (35) at the bottom. Vessel (31) contains working fluid in liquid and vapor phases, maintained at temperature T_{Low} by thermal transfer element (23). Working fluid vapor (38), (39) fills the void volumes in vessels (30), (31) at a pressure p(T_{Low}) which in the present context shall be assumed close to the working fluid liquid/vapor equilibrium pressure at T_{Low}. This pressure acts on the free surface of the hydraulic liquid (35) and is transmitted via the channel (20) to the hydraulic device (21) which is subjected to a differential pressure p(T_{High})−p(T_{Low}). By allowing the hydraulic liquid to flow through the hydraulic device, e.g. a turbine, mechanical energy can be extracted. As soon as hydraulic liquid is drawn from the vessel (29), the expanding vapor phase working fluid (36), (37) in vessels (28), (29) experience a lowered pressure and cooling, which in turn prompts net evaporation from the working fluid liquid phase (14) and further cooling. At the same time, hydraulic liquid flows into vessel (30). This may raise the temperature and pressure in vessels (30), (31) and contribute to reducing the pressure differential through the hydraulic device (21). In order to ensure that the flow through the hydraulic device be sustained, the thermal transfer element (23) inside vessel (31) is activated to provide cooling to maintain a working fluid temperature T_{Low} in the vessel (31). FIG. 5b shows the situation at a stage where the hydraulic liquid (34) in vessel (29) has reached a low level and the hydraulic device (21) must be stopped. As shown in FIG. 5c there now follows a reversal procedure where the thermal transfer elements (22), (23) switch function, cooling down the remaining working fluid in vessel (28) to T_{Low} and heating the working fluid in vessel (31) to T_{High}. Once this has been achieved, the hydraulic liquid is allowed to flow through the hydraulic device (assumed bidirectional) in the left direction as shown in FIG. 5c, producing mechanical power. FIG. 5d shows the situation at a later time when more of the hydraulic liquid (35) has been drained from vessel (30). The flow through the hydraulic device is then stopped, and a new reversal procedure is carried out, this time heating the working fluid in vessel (28) and cooling the working fluid in vessel (31). This restores the situation to that shown in FIG. 5a, and the system is ready for a new cycle.

The configuration shown in FIG. 1 was chosen to provide a simple introduction to the underlying principles of the present invention, and is representative of a class of embodiments where a two phase working fluid is heated, respectively cooled by heat exchangers integrated into volumes inside the hydraulic power conversion device that extracts mechanical energy. This configuration is only one of several similar variants under the present invention, including embodiments where the working fluid acts upon a separation element which forces a hydraulic fluid through the hydraulic power generation device (cf. FIGS. 4a-d, FIGS. 5a-d).

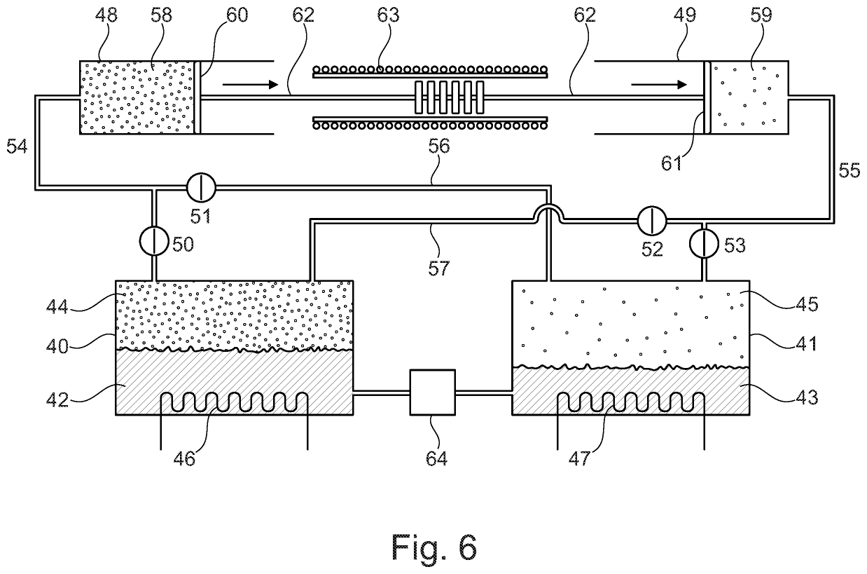

Configurations where heat exchangers are integrated into volumes inside the hydraulic power conversion device that extracts mechanical energy can provide important advantages such as being volumetrically compact. However, in cyclical operation they require sequential heating and cooling inside the same volumes, which increases cycle time and device complexity and ultimately limits the power output. These problems are avoided by employing heat exchangers integrated into volumes that are located outside the hydraulic power conversion device that extracts mechanical energy, but which are fluidly connected to the same via a system of tubes and valves. An example of this is illustrated in FIG. 6. For concreteness, it shall be assumed here that the working fluid is CO₂.

Two vessels (40), (41) contain CO₂ in liquid (42), (43) and gaseous (44), (45) states, being maintained at temperatures T_{Hot} and T_{Cold}, respectively, by heat exchange systems (46), (47). Gaseous CO₂ can flow between vessels (40), (41) and cylinders (48), (49) via control valves (50), (51), (52), (53) and tubes (54), (55), (56), (57). Gaseous CO₂ (58), (59) in cylinders (48), (49) is contained behind pistons (60), (61) that are rigidly connected by a rod (62). When the rod is translated laterally, the gas volume (58) in cylinder (48) increases while the gas volume (59) in cylinder (49) decreases, and vice versa. At the same time, lateral motion of the rod causes a linear electrical generator (63) to produce electrical power which is exported from the system. A flow control device (64) can transfer CO₂ between vessels (40) and (41).

Operation: FIG. 6 shows the system during the early phase of a power cycle: Vessel (40) is at temperature T_{Hot} and contains a two phase mixture of liquid and gaseous CO₂ at near equilibrium at this temperature, corresponding to a pressure p(T_{Hot}). Valves (50), (53) are open while valves (51), (52) are closed, and the CO₂ gas flows via tube (54) into cylinder (48), exerting pressure p(T_{Hot}) on the piston (60). If the effective area of the piston is A, this results in a force F_{Hot}=A p(T_{Hot}) acting on the rod and via the rod on the piston (61) in cylinder (49).

Vessel (41) is at temperature T_{Cold} and contains a two phase mixture of liquid and gaseous CO₂ at near equilibrium at this temperature, corresponding to a pressure p(T_{Cold}). Valve (53) is open, allowing gaseous CO₂ to flow from cylinder (49) into vessel (41) via tube (55) when the piston (61) is displaced to the right. This will take place due to the weaker force F_{Cold}=A p(T_{Cold}) exerted by the piston (61) towards the left (effective area A of piston (61) assumed equal to that of piston (60)). At this point, it may be useful to note that at e.g. T_{Hot}=15° C. and T_{Cold}=5° C. one has p(15° C.)=50 bar, p(5° C.)=40 bar.

Motion of the rod (62) to the right causes the internal volume in cylinder (48) to increase, lowering the gas pressure and temperature and drawing additional CO₂ gas from vessel (40). This in turn lowers the pressure in vessel (40), disturbing the equilibrium and eliciting increased evaporation from the liquid CO₂ (42), accompanied by cooling. This is compensated by thermal energy being supplied by the heat exchange system (46).

In cylinder (49) the internal volume decreases when the rod (62) moves to the right, compressing the gas (59) inside and raising the temperature. This causes gas to flow through the tube (55) and into vessel (41), disturbing the equilibrium by raising the temperature and pressure. The heat exchange system reacts by cooling the two phase mixture in vessel (41), causing CO₂ to transition from gas phase (45) to liquid (43).

After having moved a certain distance to the right, the pistons (60), (61) and connecting rod (62) are stopped by closing valves (50) and (53) and opening valves (51) and (52). This directs the flow of high pressure gas from vessel (40) to the cylinder (49) and opens up a flow path of gas from the cylinder (48) to the lower pressure vessel (41) where it is cooled and condensed to liquid. The net force on the rod (62) from pistons (60), (61) now acts towards the left, the rod moves and causes electrical energy to be generated in the linear electrical generator (63). Finally, the pistons (60), (61) and connecting rod (62) are stopped by closing valves (51) and (52) and opening valves (50) and (53), reconfiguring the system for a new cycle with a power stroke to the right.

Each cycle leads to CO₂ being transported from vessel (40) to vessel (41), and after a number of cycles the reservoir of CO₂ in vessel (40) would be exhausted. To avoid this, a flow control device (64) is activated to transfer liquid CO₂ between vessels (40) and (41), either continuously or intermittently. This transfer of a volume of liquid from a low pressure environment to a high pressure environment requires energy, representing a parasitic loss mechanism. In the present case one notes that the volumetric change of CO₂ between liquid and gas phases during the cycle is advantageous since the CO₂ is returned from the lower pressure vessel (41) to the higher pressure vessel (40) in a high density (liquid) form. However, there exist alternative operational modes where the pumping losses can be substantially reduced, involving a reduction of temperature differences and thus vapor pressure differences between the vessels (40) and (41): In this case, the valves (50), (53) are temporarily closed and the heat transfer elements (46), (47) are activated in a cooling, respectively heating mode. Once the pressure differential is sufficiently low, the flow control device (64) is activated in a pumping mode and the CO₂ is transferred from vessel (41) to (40). When the transfer is completed, the heat transfer elements (46), (47) are activated in a heating, respectively cooling mode, restoring the temperatures in vessels (40) and (41) to their nominal operation temperatures T_{High} and T_{Low}, respectively. This procedure may take some time, and to ensure continuous delivery of power from the generator (63), two or more parallel sets of vessels, tubes and valves similar to (40), (41), (56), (57), (50) and (53) may be incorporated in a time sharing mode.

It shall be clear to a person skilled in the art that the configurations shown in FIGS. 1, 3a-d, 4a-d,5a-d and 6 constitute only a limited set of examples chosen to illustrate how the basic principles of the present invention can be exploited. This applies both to the arrangement for extraction of mechanical power from the working fluid as well as the mechanical to electrical energy conversion. Well-known technologies for mechanical power extraction include turbines, pistons, telescopic tubes, membranes, bellows, flexible bladders or balloons, scroll expanders, and rotary screws, while devices for mechanical to electric energy conversion include rotary as well as linear generators.

1. A method for converting thermal energy into mechanical energy, the method comprising the following steps:
injecting heat into a working fluid in a heat exchange volume by a thermally connected heat exchanger, and extracting heat from a working fluid in another heat exchange volume by a thermally connected heat exchanger, thereby establishing and maintaining within predefined ranges temperatures of respectively T_{High} and T_{Low}<T_{High} and a pressure differential between working fluid vapor pressures in the two heat exchange volumes, where the heat exchange volume where heat is injected contains working fluid at least partially in the liquid phase, and the temperatures T_{High} and T_{Low} lie between the triple point temperature and the critical point temperature of the working fluid, and
by the pressure differential, driving a hydraulic power conversion device fluidly connected to the two heat exchange volumes, thereby generating mechanical energy.

2. The method according to claim 1, operating the hydraulic power conversion device under load conditions such that the fluid is discharged from the hydraulic power conversion device at a pressure equal to or exceeding the liquid to vapor equilibrium pressure of the working fluid at the temperature T_{Low}.

3. The method according to claim 1, cyclically switching the injecting heat and the extracting heat between the two heat exchange volumes.

4. The method according to claim 1, performing the injecting and the extracting heat respectively in the one and the other heat exchange volume, and cyclically switching the fluid connection between the two heat exchange volumes and the hydraulic power conversion device.

5. The method according to claim 4, where the switching the fluid connection comprises controlled opening and closing and valves and ducts between the hydraulic power conversion device and the heat exchange volumes.

6. The method according to claim 4, further comprising transferring working fluid in liquid form from the heat exchange volume where heat is extracted to the heat exchange volume where heat is injected via a flow control device, where the transferring working fluid in liquid form is performed either continuously or intermittently.

7. The method according to claim 1, where the driving the hydraulic power conversion device comprises cyclically exposing one or more displacement elements comprised by the hydraulic power conversion device to working fluid from the two heat exchange volumes.

8. The method according to claim 1, where the driving the hydraulic power conversion device comprises allowing the pressure differential to sustain a flow of working fluid in liquid or gaseous phase through the hydraulic power conversion device between the two heat exchange volumes.

9. The method according to claim 1, where the driving the hydraulic power conversion device comprises sustaining a flow of a hydraulic liquid through the hydraulic power conversion device by the differential pressure.

10. The method according to claim 9, where the sustaining the flow of the hydraulic liquid through the hydraulic power conversion device comprises transmitting working fluid vapor pressure via moveable separation elements to the hydraulic liquid.

11. The method according to claim 9, where the sustaining the flow of the hydraulic liquid through the hydraulic device comprises allowing the working fluid vapor pressures acting directly on a free surface of the hydraulic liquid.

12. A system for converting thermal energy into mechanical energy, the system comprising:
two heat exchange volumes containing working fluid, each thermally connected to a separate heat exchanger; and
a hydraulic power conversion device fluidly connected to the two heat exchange volumes, and arranged to generate mechanical energy by a pressure differential between working fluid vapor pressures in the two heat exchange volumes;
where the system is arranged for at a given time injecting heat in one of the heat exchange volumes containing working fluid at least partially in liquid phase and thereby establishing and maintaining within predefined range a temperature of T_{High}, and extracting heat from the other heat exchange volume thereby establishing and maintaining within predefined ranges a temperature of T_{Low}<T_{High}, where the temperatures T_{High} and T_{Low} lie between the triple point temperature and the critical point temperature of the working fluid.

13. The system according to claim 12, comprising means adapted to cyclically switching the injecting heat and the extracting heat between the two heat exchange volumes.

14. The system according to claim 12, where the system is adapted to constantly performing the injecting heat in one of the heat exchange volumes and the extracting heat from the other heat exchange volume, and comprises means adapted to cyclically switching the fluid connection between the two heat exchange volumes and the hydraulic power conversion device.

15. The system according to claim 14, where the means adapted to cyclically switching the fluid connection comprises valves and ducts arranged between the hydraulic power conversion device and the heat exchange volumes, and a control unit adapted to opening and closing the valves.

16. The system according to claim 14, further comprising means adapted to transferring working fluid in liquid form from the heat exchange volume where heat is extracted to the heat exchange volume where heat is injected, where the means adapted to transferring working fluid comprises a flow control device arranged in fluid connection with lower parts of the heat exchange volumes and is adapted to transfer the working fluid in liquid form either continuously or intermittently.

17. The system according to claim 12, where the hydraulic power conversion device comprises one or more displacement elements, and the system comprises means for cyclically exposing the displacement elements to working fluid from the two heat exchange volumes.

18. The system according to claim 17, where the displacement elements comprise one or more of the following: A piston, a membrane, a telescopic tube, a bellows, a flexible bladder or balloon, rotary screws.

19. The system according to claim 12, comprising means allowing the pressure differential to sustain a flow of working fluid in liquid or gaseous phase through the hydraulic power conversion device between the two heat exchange volumes.

20. The system according to claim 19, where the hydraulic power conversion device comprises a turbine, a scroll expander or a rotary screw device.

21. The system according to claim 12, comprising means adapted to sustaining a flow of a hydraulic liquid through the hydraulic power conversion device by the differential pressure.

22. The system according to claim 21, where the hydraulic liquid is water.

23. The system according to claim 21, comprising means adapted to transmitting working fluid vapor pressure via moveable separation elements to the hydraulic liquid.

24. The system according to claim 23, where the separation elements comprise at least one of the following: A piston, a membrane, a telescopic tube, a bellows, a flexible bladder or balloon.

25. The system according to claim 21, comprising means adapted to allowing the working fluid vapor pressures acting directly on a free surface of the hydraulic liquid.

26. The system according to claim 25, where the hydraulic liquid and the two liquid phase working fluids are arranged in separate lower parts of a closed volume providing for separation of the liquids, still allowing the working fluid vapor pressures acting on the free surface of the hydraulic liquid.
